(19) United States
(12) Patent Application Publication
(10) Pub. No.: US 2022/0221222 A1
(43) Pub. Date: Jul. 14, 2022

(54) DEVICE, SYSTEM AND METHOD FOR INDUSTRIAL DRYING OF A SUSPENSION OR SOLUTION

(71) Applicant: Allgaier Werke GmbH, Uhingen (DE)

(72) Inventors: Mathias Trojosky, Kirchheim unter Teck (DE); Martin Körber, Göppingen (DE); Marcel Wettring, Göppingen (DE)

(21) Appl. No.: 17/601,443

(22) PCT Filed: Mar. 10, 2020
(86) PCT No.: PCT/EP2020/056295

§ 371 Date: Oct. 5, 2021

(30) Foreign Application Priority Data
Apr. 5, 2019 (DE) 10 2019 002 528.8

(51) Int. Cl. F26B 17/28; F26B 3/20; F26B 23/04

(52) U.S. Cl. CPC F26B 17/282; F26B 23/04; F26B 17/284; F26B 3/20

(57) ABSTRACT

A device for industrial drying of a suspension or solution containing a solid material is provided, comprising a rotatably mounted cylinder having electrically conductive properties and comprising a surface for receiving the suspension or solution, and an inductor adapted to heat the cylinder inductively. The inductive heating causes that the suspension or solution received on the surface of the rotatably mounted cylinder dries and the solid material is left. Furthermore, further devices, a system, a device package, and a method for industrial drying of a suspension or solution are introduced.

The subject-matter of the present invention is a device, a device package, and a system as well as a method for industrial drying of a suspension or solution.

From the state of the art, various devices and methods for the drying of slurry, moist bulk material or liquids containing solid material in general are known. The object of drying is the obtaining (recovery) of the solid material contained in the liquids and/or moist materials so as to further process them or to transport them with reduced weight.

In industrial practice so-called drum, disk, thin-film or belt driers are known in particular which operate pursuant to the principle of contact drying:

Due to the contact between a heated surface and the moist medium to be dried, the latter is heated and the moisture present in the medium evaporates so that drying takes place. After the complete drying the dry material is left. Furthermore, known belt driers are alternatively heated convectively by air or by means of heat radiation.

Disk driers consist frequently of one or a plurality of packages of a plurality of circular disks arranged side by side in parallel and arranged on a bearing shaft. The individual disk serves as a heat exchanger transferring thermal energy to the moist medium applied on the disk, whereby the moisture in the medium evaporates. Furthermore, the individual disk is formed as a hollow body, in the cavity of which a heated heat transfer medium flows and heats the disk wall by means of heat conduction up to the external surface. Thus, the disk obtains the necessary process temperature on the surface thereof. Typical heat transfer media are, for instance, thermal oil, hot water, or saturated steam. Disk driers operated by saturated steam normally use steam pressures of 1 bar (abs.) to 7 bar (abs.) with saturated steam temperatures of 100° C. to 165° C. Moreover, the heated disks are rotated. Thus, moist media can be dried in a narrow space and be discharged subsequently. Disk driers are used especially in the fields of chemical industry, pigment industry, pharmaceutical industry, or in waste water treatment.

Disk driers operated with saturated steam are known from patent documents EP 0 521 221 B1 and

U.S. Pat. No. 4,640,345 and from utility model JP 0000S6267190 U. In these disk driers the individual rotating circular disks are continuously supplied with a liquid containing solid material in the lower region of their two circular disk surfaces by means of stationary sprayers or feed pipes. Thereby the supplied liquid dries before the disk has performed a full rotation. Thus, the disk surfaces can be freed from the dry material and be supplied again with liquid containing solid material. For freeing the disk surfaces from the adhering dry material, knives resting on the surfaces are provided which scrap off the dry material, so that it falls into a subsequent dry material delivery chute in the form of a powder or of granules or in a foil-like form. The surface thus freed is released for the supplying with further liquid.

Another problem of such drier solutions consists in the production in line with the applicable pressure equipment directives and the requirements of fulfilling official approvals of the components by a certified body such as the Technical Inspection Agency as well as the recurrent inspection of the components after a particular service life or number of transfer of charges. In connection with the piping, fittings, measuring devices, and safety installations necessary for steam guiding and the regulation thereof as well as for condensate discharge, and the complex manufacturing of the hollow disk body and the hollow bearing shaft provided for the steam supply and the condensate discharge, a system which is very complex and hence expensive to produce results.

A further disadvantage of the known steam-operated disk driers consists in that the use of heating steam as a heat transfer medium and the associated condensation of the saturated steam on the inner wall of the individual hollow disk serving as a heat exchanger indeed achieves a high thermal performance relating to the disk surface, which corresponds to the state of the art, but the temperature of the disk surfaces is always constant due to the condensation of saturated steam of a particular pressure and is only dependent on the pressure of the heating steam. Supercooling of the condensate in the heat exchanger is out of the question since “steam hammers” which are critical for the individual disk might then result in the heat exchanger. Thus, neither specific necessities of a graded temperature impact of temperature-sensitive materials, for instance, can be taken into account, nor can a temperature of the disk surfaces to be heated be easily set e.g. below 100° C. Therefore, the use of steam-operated disk driers is particularly aggravated for temperature-sensitive materials from food industry, for instance, since there is the risk that the dried goods are, due to the contact with the heated disk surfaces, subject to inadmissibly high temperatures and are thus damaged.

In order to achieve surface temperatures below 100° C., the heating steam system would have to be operated in negative pressure, i.e. be designed for pressures of less than 1 bar (abs.). Such configuration would result in that the total system again becomes considerably more complex and massive. Likewise, for the heating of the disks only a restrictedly high pressure of the heating steam of e.g. up to 7 bar (abs.) can be used since, due to the constructive design of the disks with planar faces, the design of the pressure containers which require approval is confined. The use of even higher heating steam pressures for achieving higher drying performances would require a disproportionately more stable design of the disk packages, and would mean the classification in a higher device category of the pressure container directive, whereby substantially more complex and/or more massive constructions would be required.

In addition to the disk driers described, drum driers already mentioned are further also known. In an analogous manner, a liquid to be dried is applied thinly on a drum, and is dried by the indirect heating of the drum surface, especially the jacket surface. An appropriate removing device, e.g. a scraper or a knife, removes the dry good produced from the drum surface after a certain drum rotation.

In the case of thin layer driers and/or thin layer evaporators, however, the liquid to be dried is applied on the inner jacket face of an upright or lying cylindrical pipe. The cylindrical pipe comprises a double jacket structure. For heating the surface of the cylindrical pipe a heat transfer medium, e.g. saturated steam, thermal oil, or hot water, is guided into the gap of the double jacket so as to flow around the inner jacket and heat the inner jacket face, so that the liquid applied dries completely or is concentrated. The removal of the dry material takes place by one or a plurality of rotatable removing devices within the inner jacket.

Known belt driers comprise a conveyor belt on which the material to be dried is disposed. The conveyor belt is, for instance, guided on rolls and is movable along its largest extension direction. In the case of such belt driers the conveyor belts with the moist material positioned thereon are usually supplied with a hot air stream or by a heat radiator, whereby heat is transferred to the material and the material dries.

It is thus an object of the invention to provide a device and a method for industrial drying of liquids containing solid material by means of which the disadvantages of the state of the art are overcome.

This object is solved by the device in accordance with the invention according to claims 1, 19, and 20, by the system according to claim 18, by the device package according to claim 21 , and by the method according to claim 22. Advantageous embodiments of the present invention are indicated in subclaims 2 to 17, 23 to 25.

The device according to the invention for industrial drying of a suspension or solution containing a solid material comprises a rotatably mounted cylinder having electrically conductive properties and comprising a surface for receiving the suspension or solution, and an inductor adapted to heat the cylinder inductively. The inductive heating causes that the suspension or solution received on the surface of the rotatably mounted cylinder dries and the solid material is left.

Drying means in the present invention that, from a mixture of substances, for instance, a suspension or a solution, liquid, e.g. in the form of water, is extracted by heating and evaporating and/or volatilizing. Drying is a time-relevant process, i.e. the drying proceeds over a particular time period and may be terminated at any time. In the case of complete drying the moisture contained in the substance or the mixture of substances is reduced until it has been extracted substantially completely from the substance or the mixture of substances, so that merely a dry solid material is left. Drying comprises at least one phase of a plurality of drying phases which leads to the complete drying of the substance or mixture of substances. The drying phases concern, for instance, a heating phase of the substance or mixture of substances, a further phase of the substance or mixture of substances in which the moisture contained therein evaporates and/or volatilizes, and a dried phase of the substance or mixture of substances in which the moisture has been extracted substantially completely from the substance or mixture of substances. In other words: The drying of a suspension or solution containing a solid material comprises the increasing of the solid material concentration by evaporating and/or volatilizing of the moisture in the suspension or solution, whereby the solid material is left with a residual moisture or as a concentrated solution or suspension dissolved in the residual liquid. In the edge case of the complete drying of a suspension or solution containing a solid material, substantially the solid material remains without residual moisture or only with a very small residual moisture. If the term drying is used in the following, it does not only describe the moisture content of the final product as “dry”, but also the preceding phases of the concentration in which a substantial proportion of moisture is still contained in the substance or mixture of substances.

The suspensions and solutions provided for drying may be the most various liquids containing solid material which are, for instance, used in the fields of chemical industry, primary and capital industries, or food industry. Thus, for instance, suspended ceramics, pigments or polymers, mineral slurry such as bentonite slurry, industrial effluents or else saline solutions or fermentation concentrates are suited to be dried by the device in accordance with the invention.

Due to the electrically conductive properties of the rotatably mounted cylinder it is possible to induce an electrical voltage in the body of the cylinder under the influence of a temporally varying magnetic field. The induced voltage leads to a closed current flow which is known as “eddy current”. In accordance with Joule's law, heating is thus caused in the body of the cylinder. The heating produced as a consequence of an eddy current is called inductive heating. The heated cylinder finally results in that a suspension or solution received on the surface dries by heat transfer according to the principle of contact drying. After the complete evaporation of the moisture contained in the suspension or solution the dried solid material is left as a dry material on the cylinder surface. If drying should be terminated earlier, a concentrated substance or mixture of substances is left. The introduction of the eddy current in the body of the cylinder is caused by the generated magnetic field of an inductor which varies with time. In order to generate the magnetic field, the inductor may, for instance, be supplied with an alternating voltage. The alternating voltage applied—determined by its frequency, amplitude, etc.—influences the magnetic field and hence the inductive heating effectuated. Furthermore, the eddy current induced in the cylinder body is determined by the electric conductivity and the magnetic permeability of the cylinder body. A higher electric conductivity and/or magnetic permeability and/or a higher frequency of the alternating current applied to the inductor effectuate a smaller depth of penetration of the induced eddy currents in the cylinder body, so that the inductive heating is effectuated more surficially and/or on the surface facing the inductor.

Inductive heating has, in comparison with steam heating, the advantage that, with equal thermal performance, a less massive and hence thinner and weight-reduced construction of the drier may be used. This is due to the fact that neither a cavity nor particular demands with respect to the leak proofness or pressure resistance have to be made on the cylinder components. Due to the heating in the cylinder body and especially in the surface itself, a higher active power and an improved temperature control may additionally be achieved since the thermal energy required for drying has to be transferred neither via the surface of the component from outside by radiation or convective, i.e. heat flow and transfer, or conductive heat supply, i.e. heat conduction, nor by means of a heat transfer medium from inside.

The device in accordance with the invention may further provide the possibility of taking particular product properties of temperature-sensitive products into account. Thus, surface temperatures of the cylinders below 100° C. are implementable, whereby the solution in accordance with the invention may also and especially be used e.g. for products from food industry, temperature-sensitive organic pigments, alginates, yeasts, resins, etc. The device in accordance with the invention may further provide the possibility of achieving considerably higher surface temperatures and/or thermal performances at which the liquids containing solid material dry, than it is presently possible by the use of steam-operated drier solutions due to the limitation of the pressure by breaking points of the pressure container component.

Particularly preferably, the rotatably mounted cylinder is formed as a rotatably mounted disk. A disk is a geometric body in the form of a cylinder whose radius is larger than its height. This has the advantage that, in comparison with a rotatably mounted cylinder, a more compact drier solution is enabled with an equal surface provided for receiving the liquid to be dried.

In a further preferred embodiment of the present invention the rotatably mounted cylinder is arranged horizontally in the direction of its largest extension. Its base and/or top faces point substantially in the horizontal direction. For the particularly preferred case that the rotatably mounted cylinder is a rotatably mounted disk, the disk is arranged vertically in the direction of its largest extension. Its extended side faces point substantially in the horizontal direction. Thus, superfluous liquid, i.e. the suspension or solution containing solid material, may drip off the surface so that a substantially uniformly thin film of the liquid may form on the surface of the rotatably mounted cylinder. Both the rotatably mounted cylinder and the rotatably mounted disk may also have a different orientation.

Expediently, a preferred embodiment of the present invention may comprise further rotatably mounted cylinders having electrically conductive properties and each comprising a surface for receiving the suspension or solution, and/or inductors, wherein the plurality of inductors are adapted to heat the rotatably mounted cylinder or the plurality of rotatably mounted cylinders inductively. Particularly preferably, one or a plurality of inductors is/are assigned for the inductive heating of a rotatably mounted cylinder.

Particularly preferably, the inductive heating further effectuates that the rotatably mounted cylinder is heated at least surficially. It is further expedient if the inductive heating further causes that the rotatably mounted cylinder is substantially heated surficially. The advantage of heating the rotatably mounted disk at least or even substantially and hence specifically surficially consists in that the thermal power introduced into the disk gets up to the contact face of the suspension or solution received and is, in the case of a substantially surficial heating, not obstructed by the thermal resistivities characteristic for each material. Thus, it may be ensured that a heat transfer to the heated disk takes place directly at the position of the applied suspension or solution, so that it in turn dries on the disk surface according to the principle of contact drying.

Advantageously, the inductor is arranged at a distance to the surface of the rotatably mounted cylinder. Thus, the cylinder surface is released for receiving the suspension or solution and is not covered by the inductor. Therefore, the drying capacity of the cylinder may be maximized. Expediently, the inductor is also arranged stationary with respect to the rotatably mounted cylinder, so that the inductor does not move along with a rotating cylinder. This is of advantage insofar as a larger area of the cylinder body is heated than for an inductor which is arranged on the cylinder and therefore moves along. This enables a compact construction which is substantially restricted to the extension of the cylinder.

Particularly preferably, the rotatably mounted cylinder comprises an axis of rotation on which it is rotatably mounted. The inductor is adapted to surround the cylinder at two opposite sides of the surface along and/or orthogonally to the axis of rotation. The advantage consists in that the suspension or solution received on the surface of the rotatably mounted cylinder dries on the respective two opposite sides of the surface along and/or orthogonally to the axis of rotation. Thus, it is possible to heat the jacket face and the side faces of the cylinder along the axis of rotation with one single inductor and to thus effectuate drying of the liquid containing solid matter both in an energy-efficient and in a material-saving manner on these faces.

Preferably, the method of inductive transverse field heating is chosen. Other methods such as the inductive longitudinal field heating are, however, also possible.

Particularly preferably, the rotatably mounted cylinder comprises an axis of rotation, wherein the inductor is arranged coaxially to the axis of rotation. This has the advantage that, after an appropriate rotation of the cylinder, its surface is heated in the form of an annular face on which the received suspension or solution dries. It is thus possible to heat a larger area of the cylinder surface with one single inductor than it is for an inductor which is arranged axially.

Expediently, the rotatably arranged cylinder comprises a heterogeneous electric conductivity and/or magnetic permeability such that the rotatably mounted cylinder is inductively heated more intensely surficially. In contrast to a body with a homogeneous electric conductivity and magnetic permeability this has the advantage that a larger proportion of thermal energy is induced in the edge region of the cylinder surface and hence closer to the contact face which receives the suspension or solution. Thus, more energy-efficient drying can be achieved.

Preferably, the rotatably mounted cylinder may, instead of one single material, also be composed, for instance, in the form of a “sandwich” construction, of a plurality of layers of different materials, e.g. of mild steel/constructional steel, ferritic stainless steel, copper, graphite, or others, namely such that both the demands of a preferably good degree of efficiency of the inductive heat introduction and the demands of an optimal heat transfer and heat storage, a simpler construction, and also the demands of a possible corrosive or abrasive effect of the substances to be dried are taken into account.

Particularly preferably, the device in accordance with the invention further comprises a voltage source adapted to supply the inductor controllably with an electric alternating voltage so as to heat the rotatably mounted cylinder consistently. A consistent heating achieves a consistent drying process, so that the suspension or solution is always dried within the same time and/or—in the case of a cylinder rotating at constant rotating speed—after the same cylinder rotation.

Depending on the demands on the drying process an the possibly required control thereof, and depending on the demands of the product in accordance with the possible temperature sensitivity thereof, a plurality of inductors may be distributed along the circumference of the cylinder for a particularly graded heat introduction into each region of the rotatably mounted cylinder. Specific formats of the inductors may be used such that an optimal covering of the cylinder surface is achieved.

Expediently, the rotatably mounted cylinder comprises a side face forming along the direction of the largest extension of the rotatably mounted cylinder, wherein the inductor comprises an elongated electrical conductor which is wound along the direction of the largest extension of the rotatably mounted cylinder such that the wound elongated electrical conductor covers at least half the side face. Thus, a majority of the side face of the rotatably mounted cylinder can be heated inductively, whereby the drying process is accelerated.

Particularly preferably, the device in accordance with the invention comprises further inductors adapted to heat the cylinder inductively, wherein the one and the further inductors are wound circularly, spirally, or triangularly, and wherein the one and the further inductors are distributed along the circumference of the cylinder and the direction of the largest extension of the rotatably mounted cylinder. Depending on the demands on the drying process it is possible to implement a particularly finely graded heat introduction into each region of the cylinder with an arrangement of inductors distributed along the circumference of the cylinder.

Expediently, the inductor comprises an elongated electrical conductor wound along the direction of the largest extension of the rotatably mounted cylinder and the circumference of the cylinder such that the wound elongated electrical conductor comprises a varying winding density along the circumference of the cylinder. The winding of the inductor is preferably designed such that the elongated electrical conductor comprises sections positioned side by side. Thus, a heat introduction which is more differentiated and/or graded along the circumference of the cylinder can be induced in the rotatably mounted cylinder by means of an inductor which is adapted to the respective drying task. Moreover, one-piece designs of the inductor(s) enable simpler designs of the electrical devices for the supply of the inductor(s) (oscillating circuits, generators).

The regulation and monitoring of the temperature of the rotatably mounted cylinder takes place advantageously by a measurement of the surface temperature of the cylinder, e.g. by a contact-free infrared probe. The signal obtained serves in the drying process for the influencing of the heat introduction by an electric performance regulation of the device/the system. Additionally, the inductive heat introduction may be controlled by a measurement of the resulting product temperature and/or the dry material moisture.

Particularly preferably, the inductor is designed to be tubular so as to receive a coolant there through, whereby the inductor is cooled. This is particularly advantageous since it guarantees the operating ability of the inductor even for high powers of the supplied alternating voltage or for high ambient temperatures.

Expediently, the device in accordance with the invention comprises a cooling system adapted to supply and discharge the coolant to/from the inductor. Due to the supply and discharge of the coolant it can be guaranteed that the heat generated during the operation of the inductor is transferred to the coolant supplied and is subsequently discharged. The inductor thus obtains a stable operating temperature and breakdown by overheating is obviated.

In order to enable the cooling of the heat generated in the inductor, the inductors are made of pipe-shaped metal, e.g. of copper. For cooling, water of a supply temperature of e.g. 20° C. is guided through the pipes. The water is heated in the inductor to 30° C., for instance, and is subsequently cooled again to the supply temperature of 20° C. in a heat exchanger.

Preferably, copper pipework with an outer diameter of 10 mm, for instance, and a wall thickness of 1 mm, for instance, is used for the construction of the inductor. For good workability and, for instance, for achieving high stiffness, the pipework may also comprise other cross-sections, e.g. be square.

Particularly preferably, considerably higher temperatures of e.g. 80° C. to 95° C. are provided for discharging the heat from the inductor. This may either be achieved in that substantially smaller amounts of water are used for cooling, or that a cooling water cycle with high water throughput is operated at a higher temperature level altogether with a cooling water supply temperature of approx. 80° C. and a cooling water return temperature of approx. 95° C. The cooling water of increased temperature thus accruing is guided, by means of pipework, for instance, through a liquid receiver for the liquid to be dried, which is arranged upstream of the supply of the liquid to the drying device in accordance with the invention. The pipework in the liquid receiver through which the heated cooling water flows is designed as a heat exchanger with a preferably large surface, so that the cooling water is capable of giving off its heat to the liquid to be dried in the liquid receiver. The heat dissipated from the inductors by the cooling water is thus recovered and used for the pre-heating of the liquid to be dried.

Particularly preferably, the device in accordance with the invention comprises an application device adapted to apply the suspension or solution on the surface of the rotatably mounted cylinder, especially on the side face(s) along the direction of the largest extension. The application device enables, by its capability of applying the liquid to be dried mechanically on the surface of the cylinder, that the process of application is automated. It further contributes to it that, also in respect of time, approximately the same amount of liquid is applied on the rotatably mounted cylinder, so that high process reliability results during drying.

Expediently, the device in accordance with the invention comprises a removing device adapted to remove the left solid material from the surface of the rotatably mounted cylinder, especially from the side face(s) along the direction of the largest extension. Thus, the cylinder surface is released again after the drying of the received suspension or solution, so that the released surface may receive further liquid containing solid material. Thus, the drying process is capable of continuously producing dry material. Particularly preferably, the removing device in accordance with the invention is a knife scraping the dry material off the surface of the rotatably mounted cylinder.

Since the rotatably mounted cylinder(s) comprise(s) a heat storage capacity corresponding to the materials used, a fading temperature profile will form in the regions of the cylinders directly upstream of the position of the removing device for removing the dried solid materials from the cylinder surface, said temperature profile being dependent on the residual moisture of the solid material. The invention is thus advantageous especially for temperature-sensitive goods as compared to the previously known heating by saturated steam where the drum and/or disk temperature still increases especially in the regions of decreasing solid material moisture and approaches the saturated steam temperature of the heating steam.

In order to avoid pollution of the electrically conductive parts of the inductors and/or to protect the electrically conductive parts, the inductors are, in a preferred embodiment, provided with a non-conductive and non-magnetic coating or placed in a housing of a non-conductive material which allows the electromagnetic waves to pass through without hindrance and which does not heat up itself during operation. Glass or else a suitable plastic material may be used as a material for such housings. The use of a resin, e.g. an artificial resin, is also possible, which offers the advantage that the inductors may be molded firmly in the artificial resin in the manufacturing process. Usable artificial resins are known from transformer production where the windings of the coils are often also molded. Thus, a particularly tight and permanent sealing of the inductors is achieved.

In a further preferred embodiment of the present invention the inductor, preferably also further inductors, is/are arranged integratedly within the rotatably mounted cylinder. The inductor(s) is/are, for instance, arranged in a cavity of the rotatably mounted cylinder and are enclosed by the cylinder. In this embodiment the inductor(s) is/are further rotated with the cylinder via a joint shaft. The electric supply of the inductor(s) is performed via a hub, for instance, via a brush system capable of transferring the required voltage. Such arrangement is advantageous so as to protect the inductor from corrosion, wear, or pollution by the liquid containing solid material. Such arrangement is, for instance, also of advantage e.g. for hygienic reasons so as to keep the liquid to be dried free from contamination. Due to an integrated arrangement of the inductor it is moreover easier to heat the body of the cylinder inductively homogeneously. Thus, the inductor may, for instance, fill the entire cavity along the direction of extension of the cylinder so as to heat the surface along the direction of extension of the cylinder.

Particularly preferably, the rotatably mounted cylinder comprises a shaft, wherein the shaft is drivable via a direct coupling. In comparison to steam-heated drum and/or disk driers a substantially simpler method may be used for the drive for the rotation of the drum and/or disk since the steam connections and steam supply pipes required for steam heating are omitted.

For the device in accordance with the invention gear motors with modern direct couplings, so called attachable gear motors, may be used. Attachable gear motors are particularly robust and easy to change in the case of damage due to the direct coupling. Thus, a more reduced service and maintenance effort results than for gear motors which are coupled to the bearing shaft of steam-operated drier solutions.

Particularly preferably, the device in accordance with the invention comprises a total of four, six, eight, ten, or twelve, or even more rotatably mounted cylinders and/or disks. The rotatably mounted cylinders and/or disks may e.g. be arranged centrically on an axis of rotation or bearing shaft or be distributed at a distance on a plurality of axes of rotation or bearing shafts.

If a plurality of individual inductors are used per cylinder, they may be controlled individually and their supply voltages may be controlled with respect to the frequency, etc. such that individual regions of the cylinder on which the liquid containing solid material to be dried or else also the solid material already dried and having a particular residual moisture is present, experience a graded, varying introduction of heat and thus obtain specifically different temperatures. Especially in the regions in which the good to be dried is still present as a liquid on the cylinder, a considerably higher introduction of heat may take place since moist goods are cooled by the evaporation of the water and/or solvent and the risk of overheating of both the cylinder and the material during drying is thus low.

In the regions of the rotating cylinder, e.g. shortly upstream of the region of the removing device for removing the dried solid material, in which the good is already largely dried and only little residual moisture has to be removed until the target moisture has been reached, considerably less heat introduction and hence lower temperatures may be used due to the individual regulation of the performance of individual inductors, whereby it is avoided that temperature-sensitive goods overheat, sinter, and are damaged during drying.

In order to achieve, with non-corrosion resistant materials, good corrosion resistance to the liquid to be dried as well as abrasion resistance to mechanical wear, the cylinders may be provided with a coating resistant to corrosion and wear. These coatings may be both of metallic nature, e.g. alloys of hard metals, and of non-metallic nature, e.g. ceramics. Non-metallic coatings have the effect that the heat generated by the induction is introduced deeper into the component and/or the cylinders, whereas in the case of electrically conductive materials of the coatings a significant proportion of the heat is already induced in the coatings.

In a further embodiment of the present invention, the cylinder is formed as a drum (i.e. also in the form of an open tube), wherein the jacket face of the cylinder is larger than the two (possibly available) side faces together. With such relation of the faces of the cylinder the drying process is implemented on the jacket face. In this embodiment of the present invention it is meaningful that the inductor(s) is/are provided or arranged in the interior of the cylinder. Due to the electric conductivity of the jacket face of the cylinder it is expedient to manufacture it of a massive material. The further properties may substantially be assumed from the other embodiments as described above.

In a further embodiment of the present invention, the drum is not formed of a substantially rigid and indeformable cylinder and/or tube, but of a flexible belt material having electrically conductive properties, which may be formed as an endless belt or conveyor belt deflected via rolls arranged at the ends of the revolving belt. This arrangement in accordance with the invention allows the inductors to be arranged substantially flat under or else above the belt material and are thus capable of heating a plane face uniformly.

In accordance with a further aspect the invention relates to a device for industrial drying of a suspension or solution containing a solid material, comprising: a cylindrical pipe having electrically conductive properties and comprising an inner jacket face for receiving the suspension or solution; an inductor adapted to heat the cylindrical pipe inductively, wherein the inductive heating causes that the suspension or solution received on the inner jacket face of the cylindrical pipe dries and the solid material is left.

In a preferred embodiment of the present invention the cylindrical pipe is arranged vertically in the direction of the largest extension thereof. Its openings at the front sides point substantially in the vertical direction. Thus, superfluous liquid, i.e. the suspension or solution containing solid material, may run off the inner jacket face, so that a substantially uniformly thin film of liquid may form on the inner jacket face of the cylindrical pipe. The cylindrical pipe may also have a different orientation.

Preferably, the inductor adapted to heat the cylindrical pipe inductively is arranged outside of the cylindrical pipe. Preferably, the method of inductive longitudinal field heating is used. Here, the inductor(s) may be arranged such that they surround the pipe from outside.

In accordance with a further aspect the invention relates to a device for industrial drying of a suspension or solution containing a solid material, comprising: a conveyor belt having electrically conductive properties and comprising a surface for receiving the suspension or solution; an inductor adapted to heat the surface inductively, wherein the inductive heating causes that the suspension or solution received on the surface of the conveyor belt dries and the solid material is left.

Preferably, the conveyor belt is arranged horizontally in the direction of the largest extension thereof. Preferably, the conveyor belt is further inclined about the direction of the largest extension thereof in the vertical direction. Thus, superfluous liquid, i.e. the suspension or solution containing solid material, may run off the surface, so that a substantially uniformly thin film of liquid may form on the surface of the conveyor belt. The conveyor belt may also have a different orientation.

In accordance with a further aspect, the invention relates to a device package for industrial drying of a suspension or solution containing a solid material. The device package in accordance with the invention comprises a plurality of rotatably mounted disks having electrically conductive properties, wherein each rotatably mounted disk comprises a surface for receiving the suspension or solution, wherein the rotatably mounted disks are arranged along an axis of rotation at a distance to each other. Moreover, the device package in accordance with the invention comprises inductors adapted to heat the rotatably mounted disks assigned to them inductively, wherein the inductors are arranged between the plurality of rotatably mounted disks. The inductive heating causes that the suspension or solution received on the surfaces of the rotatably mounted disks dries and the solid material is left.

Preferably, the plurality of rotatably mounted disks is arranged such that the rotatably mounted disks are each arranged vertically in the direction of the largest extension thereof. Their extended side faces each point substantially in the horizontal direction.

In accordance with a further aspect, the invention relates to a system for industrial drying of a suspension or solution containing a solid material. The system in accordance with the invention comprises the device in accordance with the invention, wherein the inductor is of tubular design so as to receive a coolant there through, whereby the inductor is cooled, and wherein the device comprises a cooling system adapted to supply and discharge the coolant to/from the inductor. The system moreover comprises a heat exchanger, wherein the cooling system is connected to the heat exchanger so as to cool the coolant and to heat the suspension or solution. Particularly preferably, the flow of the suspension or solution to be dried is, before it is supplied to the device in accordance with the invention for drying, fed into the heat exchanger, wherein the coolant is guided as a counterflow in a separate cycle and pre-heats the suspension or solution to be dried by heat transfer. The use of the heat exchanger reduces the heat losses of the system and increases the total degree of efficiency of the drying.

Advantages of the devices in accordance with the invention or of the system and the embodiments thereof as well as further expedient embodiments may be taken correspondingly from the first-mentioned device in accordance with the invention, as described above.

In accordance with a further aspect the invention relates to a method for the industrial drying of a suspension or solution which will be described in the following.

The method for industrial drying of a suspension or solution containing a solid material in accordance with the invention comprises the following method steps:
receiving the suspension or solution on a surface of a rotatably mounted cylinder having electrically conductive properties; and
inductively heating the rotatably mounted cylinder so as to dry the received suspension or solution such that the solid material is left.

Particularly preferably, the inductive heating is carried out at least surficially in the rotatably mounted cylinder.

Expediently, the method in accordance with the invention further comprises the following steps:
applying the suspension or solution on the surface of the rotatably mounted cylinder; and
removing the left solid material.

Advantages of the method in accordance with the invention and its embodiments as well as further expedient embodiments may be taken correspondingly from the device in accordance with the invention, as described above.

The invention enables the direct use of electrical energy and the use thereof for heating the cylinder for drying a liquid containing solid material with a high degree of efficiency, whereby the providing of heating steam from a complex steam network and the complex pipework and fittings may be omitted. Furthermore, instead of the drums or disks formed as hollow pressure containers with the necessity of evidencing the pressure resistance and the absolute tightness of the entire components inclusive of the necessary inspection and approval by an officially certified body, a simple massive structural shape of the drum and/or disk of a conductive metallic material may be chosen, which simplifies the manufacturing of an individual drum and/or disk and/or an appropriate package considerably. The use of fossil fuels for the generation of heating steam with the known partially low degrees of efficiency due to waste heat losses becomes likewise unnecessary, which will be of increasing importance especially in the future, the more sustainably gained electrical energy from renewable energy sources (solar, water power, wind) will be available. The invention can thus contribute to the avoidance or reduction of CO₂ emissions.

Preferred embodiments of the present invention will be explained in detail by means of the following drawings.

There show:

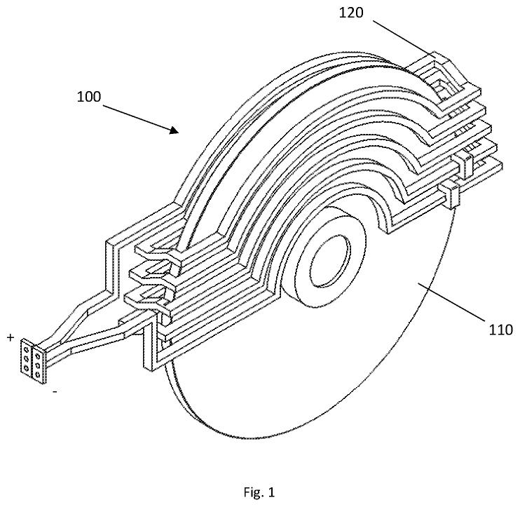

FIG. 1 a perspective view of a first embodiment of the device in accordance with the invention;

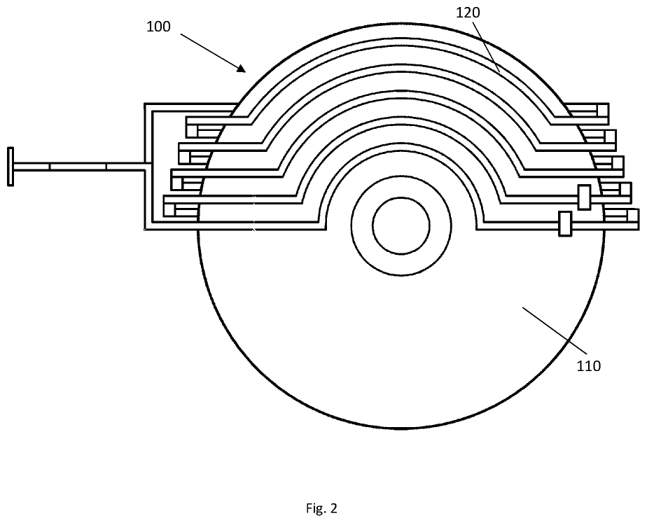

FIG. 2 a side view of a first embodiment of the device in accordance with the invention;

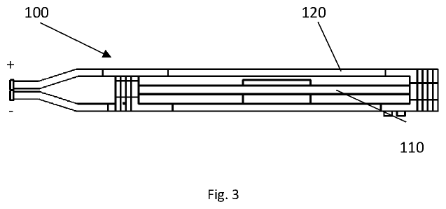

FIG. 3 a top view of a first embodiment of the device in accordance with the invention;

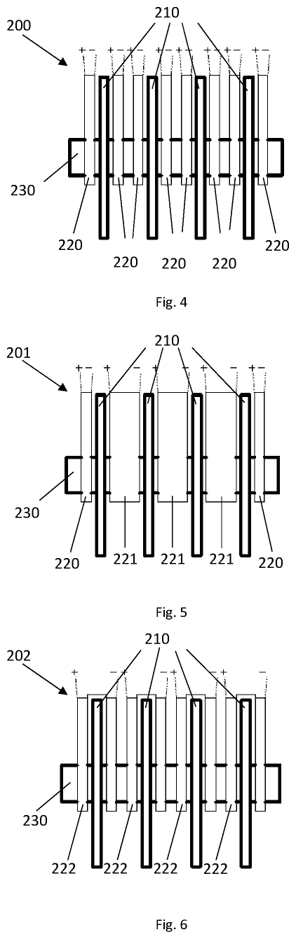

FIG. 4 a front view of a first embodiment of the device package in accordance with the invention;

FIG. 5 a front view of a second embodiment of the device package in accordance with the invention;

FIG. 6 a front view of a third embodiment of the device package in accordance with the invention;

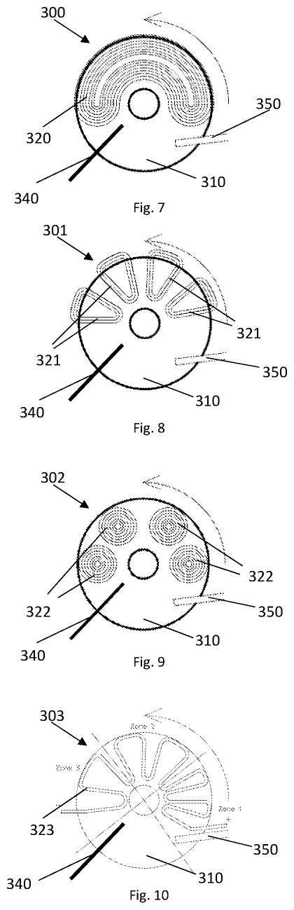

FIG. 7 a side view of a second embodiment of the device in accordance with the invention;

FIG. 8 a side view of a third embodiment of the device in accordance with the invention;

FIG. 9 a side view of a fourth embodiment of the device in accordance with the invention;

FIG. 10 a lateral view of a fifth embodiment of the device in accordance with the invention;

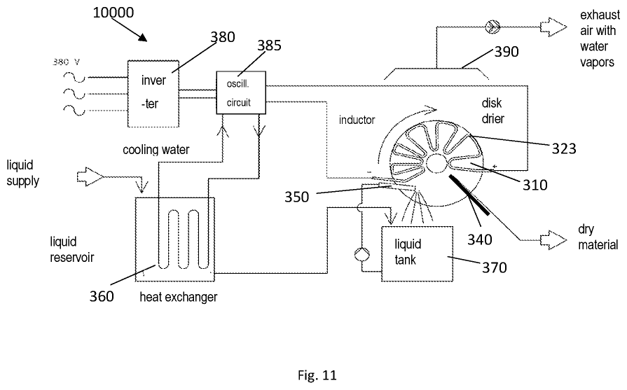

FIG. 11 a schematic view of an embodiment of the system in accordance with the invention.

FIGS. 1 to 3 show different views of a first embodiment of the device 100 in accordance with the invention for the industrial drying of a suspension or solution. The device 100 comprises a rotatably mounted disk 110 having electrically conductive properties, wherein the disk 110 is of circular design, and an inductor 120. The disk 110 is provided with a centrically arranged opening so as to push it onto a shaft and fasten it. Preferably, the disk 110 contains steel, ferritic stainless steel, copper, and/or graphite. Other electrically conductive materials are, however, also conceivable. The diameter of the disk 110 is preferably 500 to 1500 mm. Particularly preferred, the disk thickness is 5 to 15 mm. The inductor 120 comprises an elongated conductor, e.g. a wire. In order to avoid pollution of the electrically conductive parts of the inductor 120, a non-conductive and non-magnetic coating may be applied. Also conceivable is a housing (not illustrated) of a non-conductive or magnetizable material which encloses the inductor 120. Suitable materials for protection of the inductor 120 are, for instance, glass, plastics, or artificial resins. Furthermore, the inductor 120 is wound around the disk 110. The wound arrangement may surround the disk surface, preferably half the disk surface. In the embodiment of FIG. 1 the winding of the inductor 120 starts at the level of the horizontal disk diameter and reaches to the upper edge of the disk 110. The contactable end portions of the inductor are positioned at a distance on a front side of the disk 110. The distance between the individual wound conductor layers of the inductor 120 may be between 10 and 50 mm. In order to keep the centrical opening of the disk 110 free, the elongated conductor comprises circular portions which are arranged concentrically over the opening. The radii of the circular portions increase with increasing distance from the centrical opening of the disk 110. Between the disk surface and the elongated conductor a gap is available, so that the rotatably mounted disk 110 is freely movable and can be rotated. A preferably small distance of the inductor 120 from the rotatably mounted disk 110 is advantageous since this determines the degree of efficiency of the induced heat introduction. Preferably, the distance of the inductor 120 from the disk 110 is 3 to 10 mm. The wound arrangement of the inductor 120 around the disk 110 is chosen such that, on supply of the inductor 120 with an alternating voltage, an eddy current is induced in the body of the disk 110. The magnetic field generated by the inductor 120 is substantially oriented in the direction of the disk surface. Due to the Joule's heat produced as a consequence of the induced eddy current, the disk 110 is heated. A liquid containing solid material which is applied on the surface of the disk 110 would thus dry according to the principle of contact drying. The disk 110 further comprises a particular heat capacity determined by the material selected or by the materials composed. The region of the disk 110 which is wound around by the inductor 120 is heated directly inductively by the inductor 120 and thus obtains the necessary operating temperature for drying the liquid containing solid material received on the surface of the disk 110. The remaining region of the disk 110, however, has a lower temperature. It depends on the material and the heat capacity and/or heat conductivity thereof and on the speed of rotation of the disk 110 how the temperature profile is adjusted in the region of the disk 110 which is directly heated inductively and in the region of the disk 110 which is not directly heated inductively.

FIGS. 4 to 6 show different embodiments of the device package 200 for the industrial drying of a suspension or solution in a front view. In the embodiments the device packages 200 in accordance with the invention consist of four disks 210 which are centrically fastened on a joint bearing shaft and are arranged in parallel to each other. The individual disks 210 are, for instance, formed as in the embodiment of FIGS. 1 to 3. FIG. 4 illustrates an embodiment in which two inductors 220 are assigned to each disk 210. The inductors 220 are moreover arranged such that they are capable of each heating a single disk 210 inductively in the region of one of the side faces thereof. The side faces are positioned along the direction of extension of the disks 210. FIG. 5 illustrates an embodiment in which an inductor 221 is arranged between two disks 210. The inductors 221 heat the side faces of those disks 210 inductively which are arranged adjacently to the inductors 221. The disks 210 which are positioned outside in this device package in accordance with the invention are, moreover, each heated inductively with an inductor 220 at their outer side faces. FIG. 6 illustrates a further embodiment of the device package in accordance with the invention. An inductor 222 is assigned per disk 210. The inductors 222 are such that they heat the disk 210 assigned to them at the opposing side faces along the axis of rotation and/or bearing shaft 230 inductively. The inductors 222 may, for instance, each extend from one side face over the disk edge and to the opposite side face.

FIGS. 7 to 10 show further embodiments of the device 300, 301, 302, 303 in accordance with the invention in a side view. Different configurations are illustrated for the arrangement of the inductor(s). Depending on the demand on the drying process a plurality of inductors may be distributed along the circumference of the disk 310 for a graded heat introduction into each region of an individual disk 310. In FIG. 7 the inductor 320 is arranged adjacently and at a distance to a side face of the disk 310. Moreover, the inductor 320 comprises an elongated conductor which is wound along the direction of extension of the disk 310 such that the inductor 320 wound along the direction of extension of the disk 310 covers the one side face of the disk 310. Preferably, the inductor 320 comprises two circular portions arranged coaxially about the axis of rotation of the disk 310. The radius of the outer circular portion is preferably about as large as the radius of the disk 310. This embodiment of the invention moreover comprises a removing device 340 and an application device 350. The application device 350 is adapted to apply the liquid containing solid material on the disk 310. The removing device 340, however, is adapted to detach the dry good from the surface of the disk 310, e.g. by a knife resting on the surface. The application device 350 and the removing device 340 are, for instance, arranged adjacently to the disk 310 in that region that is not covered by the inductor 320. In FIGS. 8 and 9 arrangements with a plurality of, e.g. four, individual inductors 321 are shown. If a plurality of individual inductors 321 is used, they may be controlled individually. Both the supply voltage of the inductors and the frequency thereof may be controlled such that individual regions of the disk on which the liquid containing solid material to be dried or else the solid material already dried and having a particular residual moisture is present, experience a graded, varying heat introduction and thus obtain specifically different temperatures. FIG. 8 shows an embodiment of the device 301 in accordance with the invention, wherein the inductors 321 are wound from a respective elongated conductor in a triangle shape along the direction of extension of the disk 310. The inductors 321 are arranged coaxially along the circumference. The inductors 321 may additionally be oriented such that a corner of the triangle-shaped winding of each inductor 321 points to the axis of rotation and/or the bearing shaft. The inductors 321 at one of the side faces of the disk 310 may be within the disk radius or project there above. FIG. 9 illustrates a similar arrangement of the inductors 322 as in the embodiment of FIG. 8. In the embodiment of FIG. 9, the inductors 322 are wound circularly or spirally from an elongated conductor. FIG. 10 shows an embodiment of the device 303 in accordance with the invention in which the inductor 323 is wound from an elongated conductor and comprises a varying winding density along the disk circumference. The winding density may be determined by the distance of adjacent portions of the elongated conductor. A higher winding density means a smaller distance of the adjacent portions of the elongated conductor, and vice versa. The winding density may be of varying intensity by the zone. It may, for instance, be the most intense in the region of the application device and the least intense in the region of the removing device. Such configuration is of advantage since the moisture content of the applied liquid containing solid material is highest directly after applying on the surface of the disk 310 and a large amount of moisture may evaporate. In the region of the removing device the moisture content of the liquid containing solid material is considerably lower, so that a reduced heat introduction in this region of the disk 310 is sufficient to make the residual moisture evaporate. For temperature-sensitive solid materials it may, moreover, be important that they do not exceed a particular temperature so as not to be damaged.

FIG. 11 shows a schematic view of an embodiment of the system in accordance with the invention. The system illustrated comprises a rotatably mounted disk 310, an inductor 323, a removing device 340, and an application device 350. These components of the system have already been explained in detail before. Furthermore, the system comprises a liquid supply which opens into a liquid tank 370 in which the liquid containing solid material destined to be dried is collected. The application device 350 is connected to the liquid tank 370 to transport and supply the liquid containing solid material from the tank to the surface of the disk 310. Superfluous liquid drips off the disk surface and returns to the liquid tank. Furthermore, the inductor 323 is coupled to a cooling cycle. Coolant is supplied to the inductor 323, which is, for instance, of tubular design, so as to receive the coolant there through. Under normal operating conditions the inductor 323 heats up, the coolant supplied dissipates the heat of the inductor 323 by heat transfer to the coolant. The heated coolant may then be fed into the heat exchanger 360, wherein the liquid supply is pre-heated by the heated coolant as a counterflow before it gets into the liquid tank 370. Thus, heat from the coolant which was withdrawn from the inductor 323 before may be recovered by the pre-heating of the liquid to be dried. The inverter 380 and the oscillating circuit 385 serve for the regulation of the alternating voltage supplied to the inductor 323. Furthermore, the oscillating circuit 385 within the system serves for the power supply of the inductor 323. The exhaust vapor in the form of the moisture evaporated from the liquid to be dried is discharged by means of the extractor 390.

With the embodiments of the device in accordance with the invention described, it is possible to implement a water evaporative power of approx. 350 kg/h in the drying process. The liquid to be dried is, for instance, a mineral suspension having a solid material content of 50 percent dry substance. The required heating power is provided by the inductive heating with a capacity of 240 kW. The inductors are supplied by a generator with a capacity of 280 kW. By this process a product amount of 437 kg/h with a residual moisture of 10 percent water is produced. The product assumes a temperature of approx. 60° C. due to the drying.

### LIST OF REFERENCE SIGNS

100, 300, 301, 302, 303 device for industrial drying of a suspension or solution
110, 210, 310 cylinder/disk
120, 220, 221, 222, inductor
320, 321, 322, 323
200, 201, 202 device package for industrial drying of a suspension or solution
230 bearing shaft
340 removing device
350 application device
360 heat exchanger
370 liquid tank
380 inverter
385 oscillating circuit
390 extractor
1000 system for industrial drying of a suspension or solution

What is claimed is:

1. A device (100, 300, 301, 302, 303) for industrial drying of a suspension or solution containing a solid material, comprising:
a rotatably mounted cylinder (110, 310) having electrically conductive properties, wherein the rotatably mounted cylinder (110, 310) is formed as a rotatably mounted disk and arranged vertically in the direction of the largest extension thereof, and the disk comprises a surface for receiving the suspension or solution;
an inductor (120, 320, 321, 322, 323) adapted to heat the cylinder (110, 310) inductively,
wherein the inductive heating causes that the suspension or solution received on the surface of the rotatably mounted cylinder (110, 310) dries and the solid material is left.

2. The device (100, 300, 301, 302, 303) with the features of claim 1, wherein the inductive heating further causes that the rotatably mounted cylinder (110, 310) is heated at least surficially.

3. The device (100, 300, 301, 302, 303) with the features of claim 1, wherein the inductor (120, 320, 321, 322, 323) is arranged at a distance to the surface of the rotatably mounted cylinder (110, 310).

4. The device (100, 300, 301, 302, 303) with the features of claim 1, wherein the rotatably mounted cylinder (110, 310) comprises an axis of rotation on which it is rotatably mounted, and wherein the inductor (120, 320, 321, 322, 323) is adapted to surround the cylinder (110, 310) at two opposite sides of the surface along and/or orthogonally to the axis of rotation.

5. The device (100, 300, 301, 302, 303) with the features of claim 1, wherein the rotatably mounted cylinder (110, 310) comprises an axis of rotation, and wherein the inductor (120, 320, 321, 322, 323) is arranged coaxially to the axis of rotation.

6. The device with the features of claim 1, wherein the rotatably mounted cylinder (110, 310) comprises a heterogeneous electrical conductivity and/or magnetic permeability such that the rotatably mounted cylinder (110, 310) is inductively heated more intensely surficially.

7. The device (100, 300, 301, 302, 303) with the features of claim 1, further comprising a voltage source adapted to supply the inductor (120, 320, 321, 322, 323) controllably with an electric alternating voltage so as to heat the rotatably mounted cylinder (110, 310) consistently.

8. The device (100, 300, 301, 302, 303) with the features of claim 1, wherein the inductor (120, 320, 321, 322, 323) is designed to be tubular so as to receive a coolant there through, whereby the inductor (120, 320, 321, 322, 323) is cooled.

9. The device (100, 300, 301, 302, 303) with the features of claim 1, wherein the rotatably mounted cylinder (110, 310) comprises a side face forming along the direction of the largest extension of the rotatably mounted cylinder (110, 310), and wherein the inductor (120, 320, 321, 322, 323) comprises an elongated electrical conductor wound along the direction of the largest extension of the rotatably mounted cylinder (110, 310) such that the wound elongated electrical conductor covers at least half of the side face.

10. The device (100, 300, 301, 302, 303) with the features of claim 1, further comprising further inductors adapted to heat the rotatably mounted cylinder (110, 310) inductively, wherein the one and the further inductors are wound circularly, spirally or triangularly, and wherein the one and the further inductors are distributed along the circumference of the cylinder and the direction of the largest extension of the rotatably mounted cylinder (110, 310).

11. The device (100, 300, 301, 302, 303) with the features of claim 1, wherein the inductor (120, 320, 321, 322, 323) comprises an elongated electrical conductor wound along the direction of the largest extension of the rotatably mounted cylinder (110, 310) and the circumference of the cylinder such that the wound elongated electrical conductor comprises a varying winding density along the circumference of the cylinder.

12. The device (100, 300, 301, 302, 303) with the features of claim 1, wherein the inductor (120, 320, 321, 322, 323) is arranged integratedly within the rotatably mounted cylinder (110, 310).

13. The device (100, 300, 301, 302, 303) with the features of claim 1, wherein the rotatably mounted cylinder (110, 310) comprises a shaft, and wherein the shaft is drivable via a direct coupling.

14. The device (100, 300, 301, 302, 303) with the features of claim 1, further comprising an application device (350) adapted to apply the suspension or solution on the surface of the rotatably mounted cylinder (110, 310).

15. The device (100, 300, 301, 302, 303) with the features of claim 1, further comprising a removing device (340) adapted to remove the left solid material from the surface of the rotatably mounted cylinder (110, 310).

16. The device (100, 300, 301, 302, 303) with the features of claim 8, further comprising a cooling system adapted to supply and discharge the coolant to/from the inductor (120, 320, 321, 322, 323).

17. A system (1000) for industrial drying of a suspension or solution containing a solid material, comprising:
a device with the features of claim 16; and
a heat exchanger (360),
wherein the cooling system is connected to the heat exchanger (360) so as to cool the coolant and to heat the suspension or solution.

18. A device for industrial drying of a suspension or solution containing a solid material, comprising:
a cylindrical pipe having electrically conductive properties and comprising an inner jacket face for receiving the suspension or solution;
an inductor adapted to heat the cylindrical pipe inductively,
wherein the inductive heating causes that the suspension or solution received on the inner jacket face of the cylindrical pipe dries and the solid material is left.

19. A device for industrial drying of a suspension or solution containing a solid material, comprising:
a conveyor belt having electrically conductive properties and comprising a surface for receiving the suspension or solution;
an inductor adapted to heat the surface inductively,
wherein the inductive heating causes that the suspension or solution received on the surface of the conveyor belt dries and the solid material is left.

20. A device package (200, 201, 202) for industrial drying of a suspension or solution containing a solid material, comprising:
a plurality of rotatably mounted disks (210) having electrically conductive properties, wherein each rotatably mounted disk comprises a surface for receiving the suspension or solution and is arranged vertically in the direction of the largest extension thereof, and wherein the rotatably mounted disks (210) are arranged along an axis of rotation at a distance to each other;
inductors (220, 221, 222) adapted to heat the rotatably mounted disks (210) assigned to them inductively,
wherein the inductors (220, 221, 222) are arranged between the plurality of rotatably mounted disks (210), and
wherein the inductive heating causes that the suspension or solution received on the surfaces of the rotatably mounted disk dries and the solid material is left.

21. A method for industrial drying of a suspension or solution containing a solid material, comprising the following method steps:
receiving the suspension or solution on a surface of a rotatably mounted cylinder (110, 310) having electrically conductive properties, wherein the rotatably mounted cylinder (110, 310) is formed as a rotatably mounted disk and arranged vertically in the direction of the largest extension thereof; and
inductively heating the rotatably mounted cylinder (110, 310) so as to dry the received suspension or solution such that the solid material is left.

22. The method with the features of claim 21, wherein the inductive heating is carried out at least surficially in the rotatably mounted cylinder (110, 310).

23. The method with the features of claim 21, further comprising the following method steps:
applying the suspension or solution on the surface of the rotatably mounted cylinder (110, 310); and
removing the left solid material.

24. The method with the features of claim 21, wherein the rotatably mounted cylinder is a rotatably mounted disk.
